(19) United States
(12) Patent Application Publication
(10) Pub. No.: US 2020/0095464 A1
(43) Pub. Date: Mar. 26, 2020

(54) Paint coat for repairing scratches on car

(71) Applicant: Yung Chang Huang, Hsinchu County (TW)

(72) Inventor: Yung Chang Huang, Hsinchu County (TW)

(21) Appl. No.: 16/699,158

(22) Filed: Nov. 29, 2019

(30) Foreign Application Priority Data
Nov. 21, 2019 (TW) 108215392

(51) Int. Cl. C09D 183/04; C09D 183/16; C09D 127/12; C08K 5/06; C08K 5/07; C08K 5/10; C08K 5/01

(52) U.S. Cl. CPC C09D 183/04; C09D 183/16; C09D 127/12; C08K 5/01; C08K 5/07; C08K 5/10; C08K 5/06

(57) ABSTRACT

A paint coat for repairing scratches on an automobile includes 2% to 90% by weight of siloxane resin, 2% to 90% by weight of polysilazane resin, 2% to 90% by weight of fluororesin, 0.001% to 10% by weight of fluorine additive, 0.0001% to 50% by weight of a second additive other than the fluorine additive, and 10% to 94% by weight of solvent. The solvent is alkane, ester, ether, or ketone.

### BACKGROUND OF THE INVENTION

### 1. Field of the Invention

The invention relates to paints and more particularly to a nanoscopic scale paint coat for repairing scratches on an automobile having improved characteristics.

### 2. Description of Related Art

It is typical to apply paint on scratches on a car for repair. However, the repaired part may be reeled after a period of time, i.e., the conventional anticorrosive paints are not poor in quality.

Thus, the need for improvement still exists.

### SUMMARY OF THE INVENTION

It is therefore one object of the invention to provide a paint coat, comprising 2% to 90% by weight of siloxane resin, 2% to 90% by weight of polysilazane resin, 2% to 90% by weight of fluororesin, 0.001% to 10% by weight of fluorine additive, 0.0001% to 50% by weight of a second additive other than the fluorine additive, and 10% to 94% by weight of solvent.

The above and other objects, features and advantages of the invention will become apparent from the following detailed description taken with the accompanying drawings.

### BRIEF DESCRIPTION OF THE DRAWINGS

FIG. 1 schematically depicts a process of repairing a scratched paint by applying a nanoscale painting material thereon according to the invention so that a paint coat is formed thereon;

FIG. 2 is a longitudinal sectional view of the paint coat, the paint, and a body part of an automobile from top to bottom;

FIG. 3 is a chart of scratch depth versus the scratched paint for a heating repair step prior to applying the painting material on the scratched paint;

FIG. 4 is a chart of scratch depth versus the scratched paint after applying the painting material according to a first preferred embodiment of the invention on the scratched paint; and

FIG. 5 is a chart of scratch depth versus the scratched paint after applying the painting material according to a second preferred embodiment of the invention on the scratched paint.

### DETAILED DESCRIPTION OF THE INVENTION

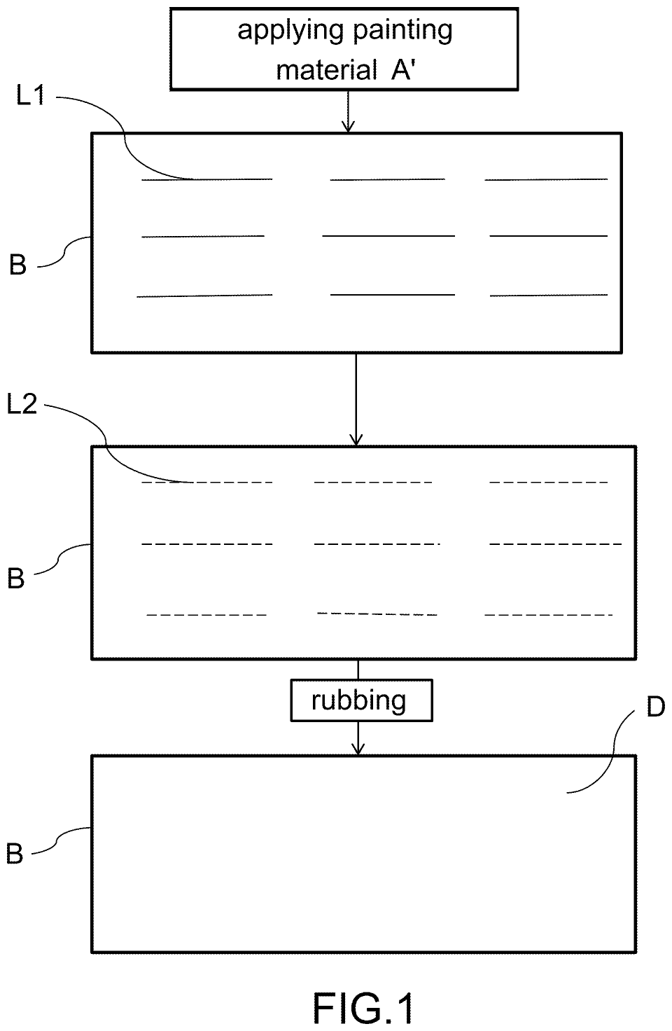

Referring to FIG. 1, a process of repairing a scratched paint B on an automobile is illustrated below. First, a hot nanoscale painting material A′ is applied on the scratched paint B by means of an applicator in a room temperature. Next, a plurality of lines L1 are formed on the scratched paint B because the nanoscale painting material A′ has permeated the scratched paint B. After 1 to 2 minutes have lapsed, the lines L1 are converted into a plurality of dashed lines L2 because the nanoscale painting material A′ has permeated the scratched paint B. Finally, after 5-7 days have lapsed, a cloth is used to rub a cured surface of the scratched paint B to form a polished surface D.

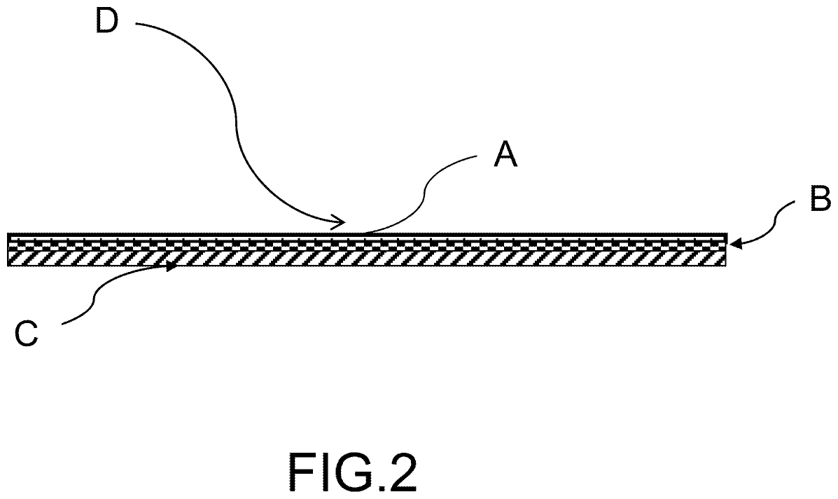

Referring to FIG. 2, the polished surface D includes, from to bottom, a nanoscale paint coat A in accordance with the invention, the paint B, and a body part C of the automobile. The nanoscale paint coat A as the subject of the invention comprises 2% to 90% by weight of siloxane resin, 2% to 90% by weight of polysilazane resin, 2% to 90% by weight of fluororesin, 0.001% to 10% by weight of fluorine additive, 0.0001% to 50% by weight of a second additive other than the fluorine additive, and 10% to 94% by weight of solvent.

Preferably, siloxane resin is implemented as glass coating and is inorganic.

Preferably, polysilazane resin is implemented as ceramic coating and is organic.

Preferably, fluororesin is implemented as fluorine coating.

Preferably, solvent is alkane, ester, ether, or ketone.

Preferably, solvent is not water or alcohol.

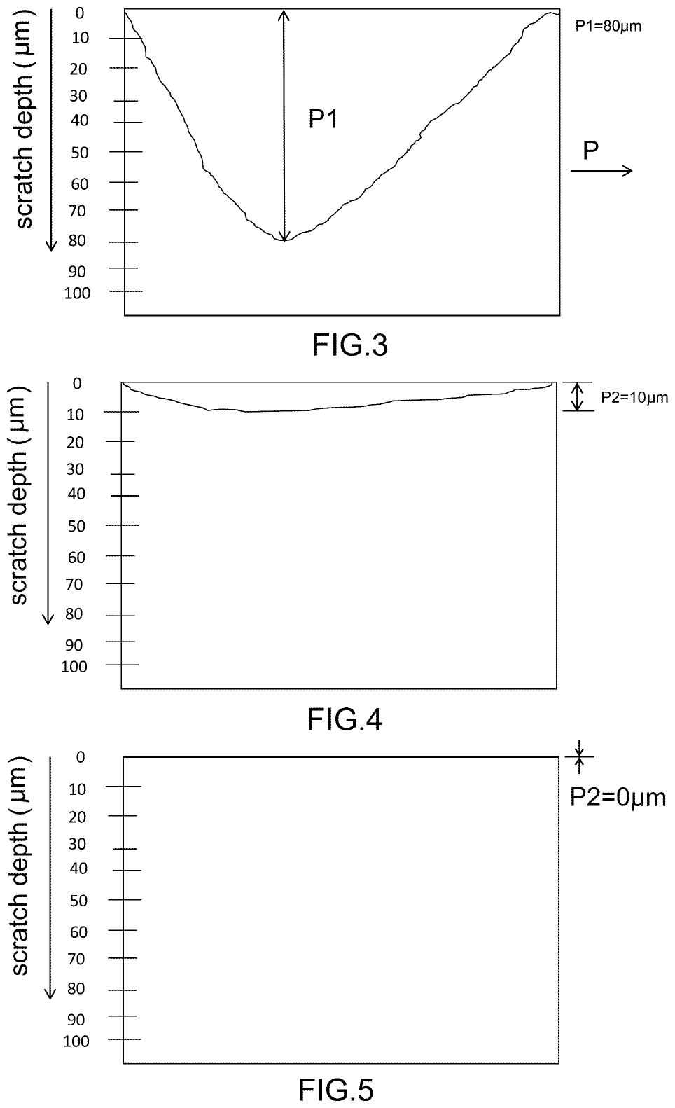

Referring to FIG. 3 in conjunction with FIGS. 1 and 2, it is a chart of scratch depth versus the scratched paint B for a heating repair step P prior to applying the painting material A′ on the scratched paint B. It shows a scratch depth P1 of 80 μm on the scratched paint B.

Thereafter, the painting material A′ is heated to 100° C. for one second. Next, the painting material A′ is applied on the scratched paint B.

Referring to FIG. 4 in conjunction with FIGS. 1 to 3, it is a chart of scratch depth versus the scratched paint B after applying the painting material A′ according to a first preferred embodiment of the invention on the scratched paint B. It shows a scratch depth P2 of 10 μm on the scratched paint B. A repair rate is (P1−P2)/P1×100%, i.e., 87.5%.

Referring to FIG. 5 in conjunction with FIGS. 1 to 3, it is a chart of scratch depth versus the scratched paint B after applying the painting material A′ according to a second preferred embodiment of the invention on the scratched paint B. It shows a scratch depth P2 of 0 μm on the scratched paint B. A repair rate is (P1−P2)/P1×100%, i.e., 100%.

While the invention has been described in terms of preferred embodiments, those skilled in the art will recognize that the invention can be practiced with modifications within the spirit and scope of the appended claims.

What is claimed is:

1. A paint coat, comprising 2% to 90% by weight of siloxane resin, 2% to 90% by weight of polysilazane resin, 2% to 90% by weight of fluororesin, 0.001% to 10% by weight of fluorine additive, 0.0001% to 50% by weight of a second additive other than the fluorine additive, and 10% to 94% by weight of solvent.

2. The paint coat of claim 1, wherein the solvent is alkane, ester, ether, or ketone.
